(19) United States
(12) Patent Application Publication
(10) Pub. No.: US 2026/0127482 A1
(43) Pub. Date: May 7, 2026

(54) USING CLASSICAL CONTROL FLOW IN QUANTUM PROGRAMMING

(71) Applicant: Classiq Technologies LTD., Tel Aviv (IL)

(72) Inventors: Amir Naveh, Haifa (IL); Shmuel Ur, Shorashim (IL); Eyal Cornfeld, Ramat Gan (IL); Nati Erez, Kfar Yona (IL); Nir Minerbi, Haifa (IL)

(21) Appl. No.: 18/932,166

(22) Filed: Oct. 30, 2024

(51) Int. Cl. G06N 10/80

(52) U.S. Cl. CPC G06N 10/80

(57) ABSTRACT

A method, apparatus and product are provided for using classical control flow in quantum programming. A quantum program that comprises a sequence of instructions including compilable instructions and a non-compilable instruction is received. A first subset of the compilable instructions is selected based on the non-compilable instruction. The first subset is compiled to obtain a first quantum circuit, which is executed using a quantum execution platform. An outcome of the execution is determined. A second subset of the compilable instructions, different from the first subset, is selected. The second subset is compiled to obtain a second quantum circuit executable by the quantum execution platform. In another aspect, compilable instructions are selected based on the type and position of a non-compilable instruction. The selected instructions are compiled to obtain an executable quantum circuit.

### TECHNICAL FIELD

The present disclosure relates to quantum computing in general, and to implementing control flow structures in quantum programming, in particular.

### BACKGROUND

Quantum computing is an emerging field that leverages the principles of quantum mechanics to perform computations. Unlike classical computers that use bits to represent information as 0 or 1, quantum computers use quantum bits or qubits that can exist in superposition states. This allows quantum computers to potentially solve certain complex problems much faster than classical computers.

Programming quantum computers presents unique challenges compared to classical programming. Quantum algorithms often require manipulating qubits through quantum gates and measurements. As quantum systems are inherently probabilistic, multiple executions of a quantum program may be needed to obtain meaningful results. Additionally, quantum states are fragile and susceptible to errors, necessitating error correction techniques. These fundamental differences from classical computing create a need for new programming paradigms and tools tailored for quantum systems.

### BRIEF SUMMARY

One exemplary embodiment of the disclosed subject matter is a method comprising receiving a quantum program comprising a sequence of instructions, the sequence of instructions comprising compilable instructions and a non-compilable instruction. The method includes selecting a first subset of the compilable instructions, wherein said selecting the first subset is performed based on the non-compilable instruction. The method further comprises compiling the first subset of the compilable instructions, whereby obtaining a first quantum circuit, executing the first quantum circuit using a quantum execution platform, and determining an outcome of the execution of the first quantum circuit. The method also includes selecting a second subset of the compilable instructions, wherein the first subset and the second subset are different, and compiling the second subset of the compilable instructions, whereby obtaining a second quantum circuit that can be executed by the quantum execution platform.

Optionally, selecting the first subset is performed based at least on a position of the non-compilable instruction in the sequence of instructions.

Optionally, the sequence of instructions comprises a first compilable instruction, the non-compilable instruction, and a second compilable instruction, arranged in that specific order within the sequence of instructions, wherein the first subset comprises the first compilable instruction and excludes the second compilable instruction, wherein the second subset comprises the second compilable instruction.

Optionally, the second subset comprises the first compilable instruction.

Optionally, the sequence of instructions comprises a first compilable instruction, the non-compilable instruction, a second non-compilable instruction, a second compilable instruction, arranged in that specific order within the sequence of instructions, wherein the first subset comprises the first compilable instruction and excludes the second compilable instruction, wherein the second subset comprises the second compilable instruction and excludes the first compilable instruction, wherein the second non-compilable instruction is an instruction that initiates a new phase of program execution or alters the control flow of the quantum program.

Optionally, the method further comprises executing the second quantum circuit using the quantum execution platform.

Optionally, the method further comprises repeatedly: selecting a subset of the compilable instructions, compiling the subset to obtain a quantum circuit, executing the quantum circuit, and determining control flow based on an outcome of the execution of the quantum circuit.

Optionally, executing the first quantum circuit is performed a plurality of times, wherein a number of times the first quantum circuit is executed depends on the determination made for determining the outcome of the execution of the first quantum circuit.

Optionally, executing the first quantum circuit is performed a plurality of times, wherein the method further comprises performing quantum state tomography on results of the plurality of executions of the first quantum circuit to reconstruct a quantum state, wherein determining the outcome is performed using the reconstructed quantum state.

Optionally, the non-compilable instruction is a control flow instruction that is based on an evaluation of a condition, wherein determining the outcome of the execution of the first quantum circuit comprises evaluating the condition.

Optionally, the non-compilable instruction is selected from a group consisting of: IF statement, DO-WHILE statement, UNTIL statement, SWITCH statement, and CONDITIONAL GOTO statement.

Another exemplary embodiment of the disclosed subject matter is a method comprising receiving a quantum program comprising a sequence of instructions, the sequence comprising a plurality of compilable instructions and at least one non-compilable instruction. The method includes selecting at least one of the compilable instructions for compiling, wherein said selecting is performed based at least on a type of the non-compilable instruction and on a position of the non-compilable instruction in the sequence. The method further comprises compiling the selected at least one compilable instruction, whereby obtaining a quantum circuit that is executable by a quantum execution platform.

Optionally, the method further comprises performing at least one early compilation step, wherein the early compilation step comprises compiling and executing at least one instruction appearing in the sequence before the position of the non-compilable instruction, and conditioning compilation of at least one remaining instruction of the quantum program upon at least one result of said early compilation step.

Optionally, the early compilation step comprises repeatedly compiling and executing the at least one instruction appearing in the sequence before the position of the non-compilable instruction, for a predetermined number of times.

Optionally, the early compilation step comprises repeatedly compiling and executing the at least one instruction appearing in the sequence before the position of the non-compilable instruction until a predetermined condition is satisfied.

Optionally, the early compilation step comprises at least two early compilation steps, and each one of the early compilation steps is repeated for a different number of times.

Optionally, the at least one non-compilable instruction defines that a set of one or more compilable instructions is to be executed a predetermined number of times, wherein the predetermined number of times is ascertainable prior to execution of the quantum program, wherein the quantum circuit comprises a sequence of replicated layers, each of which corresponds to the set of one or more compilable instructions.

Yet another exemplary embodiment of the disclosed subject matter is a system comprising a classical processor and a quantum execution platform. The system is configured to receive a quantum program comprising a sequence of instructions, the sequence of instructions comprising compilable instructions and a non-compilable instruction. The system is further configured to select a first subset of the compilable instructions, wherein the selection is performed based on the non-compilable instruction, compile the first subset of the compilable instructions, whereby obtaining a first quantum circuit, and execute the first quantum circuit using the quantum execution platform. After the execution of the first quantum circuit, the system is configured to select a second subset of the compilable instructions, wherein the first subset and the second subset are different, and compile the second subset of the compilable instructions, whereby obtaining a second quantum circuit that can be executed by the quantum execution platform.

Optionally, the non-compilable instruction does not have a counterpart instruction in any of the first quantum circuit and the second quantum circuit.

Optionally, the non-compilable instruction is a control flow instruction that is based on an evaluation of a condition, wherein the evaluation of the condition is performed after the first quantum circuit is executed and based on an outcome thereof, wherein the second subset of the compilable instructions is determined based on the evaluation of the condition.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspect of the disclosure and do not limit the scope of the disclosure. In the drawings:

FIG. 1 illustrates a flowchart for a method of processing a quantum program, in accordance with some exemplary embodiments of the disclosed subject matter;

FIG. 2A illustrates a flowchart for a method of processing a quantum program, in accordance with some exemplary embodiments of the disclosed subject matter;

FIG. 2B illustrates a flowchart for a method of processing a quantum program, in accordance with some exemplary embodiments of the disclosed subject matter;

FIG. 3 illustrates a flowchart for a method of processing a quantum program with a classical control flow instruction, in accordance with some exemplary embodiments of the disclosed subject matter;

FIG. 4A illustrates a flowchart for a method of processing a quantum program, in accordance with some exemplary embodiments of the disclosed subject matter;

FIG. 4B illustrates a flowchart for a method of processing a quantum program with early compilation, in accordance with some exemplary embodiments of the disclosed subject matter;

FIG. 4C illustrates a flowchart for a method of processing a quantum program with instruction replication, in accordance with some exemplary embodiments of the disclosed subject matter;

FIG. 5A illustrates a control flow graph for a quantum program, in accordance with some exemplary embodiments of the disclosed subject matter;

FIG. 5B illustrates an execution path for an early quantum circuit, in accordance with some exemplary embodiments of the disclosed subject matter;

FIG. 5C illustrates an execution path for a second early quantum circuit, in accordance with some exemplary embodiments of the disclosed subject matter;

FIG. 5D illustrates an execution path for a quantum program, in accordance with some exemplary embodiments of the disclosed subject matter;

FIG. 6A illustrates a control flow graph for a quantum program with looping, in accordance with some exemplary embodiments of the disclosed subject matter;

FIG. 6B illustrates a first early compilation step for a quantum program with looping, in accordance with some exemplary embodiments of the disclosed subject matter;

FIG. 6C illustrates another early compilation step for a quantum program with looping, in accordance with some exemplary embodiments of the disclosed subject matter;

FIG. 6D illustrates an execution path for a quantum program with looping, in accordance with some exemplary embodiments of the disclosed subject matter; and

FIG. 7 illustrates a block diagram of an apparatus for processing quantum programs, in accordance with some exemplary embodiments of the disclosed subject matter.

### DETAILED DESCRIPTION

One technical problem dealt with by the disclosed subject matter is implementing classical control flow structures in quantum programming. Quantum computing presents unique challenges compared to classical computing, as quantum systems operate on principles of superposition and entanglement. Traditional control flow structures like conditional statements and loops that are fundamental to classical programming do not have direct equivalents in quantum circuits. This makes it difficult for programmers familiar with classical paradigms to develop quantum algorithms that require conditional execution or repetition of quantum operations.

Additionally, quantum states are fragile and cannot be directly observed without collapsing the superposition. This poses a challenge when trying to implement conditional logic based on intermediate results of quantum computations. Classical control flow often relies on evaluating conditions and branching program execution accordingly, but directly measuring quantum states to make such decisions is not feasible without disrupting the quantum computation.

Furthermore, quantum circuits typically require a fixed structure determined at compile-time, which conflicts with the dynamic nature of classical control flow where execution paths can vary at runtime. This rigidity limits the ability to create quantum programs with adaptive behavior or iterative refinement based on partial results.

One technical solution is to introduce a hybrid approach that combines classical control structures with quantum program compilation and execution. This solution involves separating compilable quantum instructions from non-compilable classical control instructions within a quantum program. The method selectively compiles and executes subsets of quantum instructions based on the evaluation of classical control structures.

Specifically, the solution introduces new types of non-compilable instructions such as ASSERT, LABEL, GOTO, WHILE, IF, and START, which guide the compilation and execution process without being directly translated into quantum gates. When encountering a non-compilable control flow instruction, such as an IF statement or WHILE statement, the system compiles and executes a subset of preceding quantum instructions. The outcome of this execution is then used to evaluate the condition and determine the subsequent program flow.

For example, when an IF statement is encountered, the system compiles and executes the quantum instructions leading up to the IF statement. The result of this execution is used to evaluate the condition, allowing the system to determine which branch of the IF statement should be taken. Based on this evaluation, a new subset of quantum instructions is selected, compiled, and executed, effectively implementing the conditional behavior.

Similarly, loop structures are handled by repeatedly compiling and executing subsets of instructions, with each iteration potentially selecting different instructions based on the loop condition. This approach allows for the implementation of dynamic, condition-based repetition of quantum operations without requiring a fixed circuit structure. It is noted, however, that in the absence of a START statement, the outcome of the process is an executable quantum circuit that includes all the executed compilable instructions from the beginning of the program until its end. The process re-starts execution of the quantum program from the beginning even after the control flow decision is made.

The START statement may provide additional flexibility by allowing the program execution to reset and begin from a new starting point. In some aspects, this can enable more complex control flow structures and iterative algorithms in quantum programs.

In some embodiments, the solution employs an early compilation step to address the challenges of implementing classical control flow in quantum programming. This approach involves selectively compiling and executing subsets of quantum instructions based on the presence and evaluation of non-compilable control flow instructions.

In the early compilation step, when a non-compilable instruction is encountered, the system compiles and executes only the preceding compilable instructions. The outcome of this execution is then used to evaluate the condition associated with the control flow instruction. This allows the system to determine the subsequent program flow without compiling the entire quantum program at once. Based on the evaluation result, the system can then select and compile the next appropriate subset of instructions, effectively implementing conditional behavior in the quantum program.

In some embodiments, the system may handle non-compilable instructions that define a set of instructions to be executed a predetermined number of times by replicating layers in the resulting quantum circuit. When such an instruction is identified, the system may select the compilable instructions within the defined set and compile them into a quantum circuit layer. This layer may then be replicated in the final quantum circuit a number of times corresponding to the predetermined execution count. The replicated layers may be arranged sequentially in the circuit, forming a sequence that represents the repeated execution of the instruction set. This approach allows for efficient implementation of loop-like structures in quantum programs, where the number of iterations is known at compile-time, without requiring dynamic control flow during execution.

One technical effect of utilizing the disclosed subject matter is enabling the creation of more complex and adaptive quantum algorithms. By allowing classical control flow structures to guide the compilation and execution of quantum instructions, programmers can develop algorithms that respond to intermediate results and adapt their behavior accordingly. This bridges the gap between classical and quantum programming paradigms, making it easier for developers with classical programming experience to create sophisticated quantum algorithms.

Another technical effect is improved efficiency in quantum resource utilization. By selectively compiling and executing only the necessary quantum instructions based on runtime conditions, the system can avoid allocating qubits or quantum gates for branches of the program that are not taken. This can lead to more compact quantum circuits and potentially reduce the overall number of qubits required for a given computation.

Additionally, this approach enables early termination of quantum programs based on intermediate results, which can save significant computational resources. For instance, if a desired result is achieved after a certain number of iterations, the program can be terminated without executing unnecessary quantum operations.

Furthermore, the solution allows for the implementation of error mitigation strategies that adapt to the quality of quantum operations during runtime. By using classical control flow to guide the execution of quantum circuits, the system can implement adaptive error correction schemes or dynamically adjust the number of repetitions based on the observed error rates.

In some aspects, the solution may offer improved scalability due to the independent evaluation of each condition. When multiple executions are needed to evaluate a condition, such as in cases where quantum state tomography is performed, the total number of executions for the entire program may be summed rather than multiplied. This approach may allow for more efficient handling of complex quantum programs with multiple conditional statements. For example, if one condition requires 100 executions to evaluate and another requires 50, the total number of executions may be 150 rather than 5000. This additive nature of execution counts may contribute to better resource management and potentially faster overall program execution, especially for quantum algorithms with numerous branching points or nested conditional structures. This allows the solution to be applicable to practical applications and not limited to small, toy examples.

Another technical effect of the disclosed subject matter is the seamless integration of classical and quantum programming paradigms. The system may automatically handle the separation between classical and quantum portions of the program, allowing programmers to focus on algorithm design rather than low-level implementation details. This abstraction may enable developers to write a single, coherent quantum program that incorporates both classical control flow and quantum operations without explicitly managing their interaction. The system may analyze the program structure, identify compilable and non-compilable instructions, and manage the compilation and execution process accordingly. This approach may simplify the development of hybrid quantum-classical algorithms, potentially accelerating the creation of complex quantum applications in fields such as optimization, machine learning, and cryptography. By automating the handling of classical control structures within quantum programs, the solution may lower the barrier to entry for quantum programming and facilitate the transition from classical to quantum computing paradigms for a broader range of developers.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

The present disclosure relates to methods for implementing classical control flow structures in quantum programming. In some exemplary embodiments, a quantum program comprising a sequence of instructions, including compilable instructions and non-compilable instructions, is received. A first subset of the compilable instructions may be selected based on the non-compilable instruction. This first subset is then compiled to obtain a first quantum circuit, which is executed using a quantum execution platform. The outcome of this execution is determined and used to select a second subset of the compilable instructions, which is then compiled to obtain a second quantum circuit. This process allows for the dynamic selection, compilation, and execution of quantum instructions based on the evaluation of classical control structures, potentially making quantum programming more accessible and efficient. Additionally, or alternatively, the method may involve executing the first quantum circuit multiple times, with the number of executions depending on the determined outcome. This approach may provide improved scalability and resource management for quantum programs.

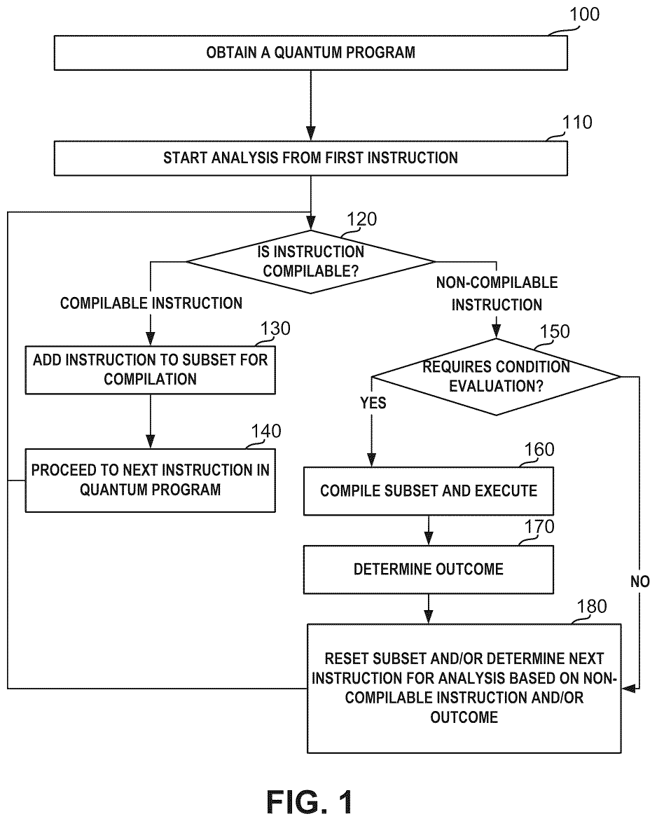

Referring to FIG. 1, the figure illustrates a flowchart for a method of processing a quantum program, in accordance with some exemplary embodiments of the disclosed subject matter.

In Step 100, a quantum program is obtained. The quantum program includes a sequence of instructions. In some exemplary embodiments, the sequence of instructions includes both compilable instructions and non-compilable instructions. Compilable instructions may be instructions that can be directly translated into quantum gates or operations. Non-compilable instructions may be instructions that guide the compilation and execution process but do not directly correspond to quantum gates or operations. Non-compilable instructions may include, for example, classical control flow instructions such as IF, WHILE, GOTO, or the like. Non-compliable instructions may include ASSERT in which a condition is evaluated and execution may proceed only if the condition is held. An additional non-compilable instruction may be a START statement. The sequence of instructions defines an order between the instructions.

In Step 110, the analysis starts from the first instruction of the sequence of the quantum program. In some cases, the first instruction appearing in the sequence according to the order defined thereby is selected. For example, the instruction at the first line is selected.

In Step 120, it is determined whether the current instruction being analyzed is a compilable instruction or a non-compilable instruction. If the instruction is compilable, the process moves to Step 130 and performs Steps 130-140. If the instruction is non-compilable instruction, the process moves to Step 150 and performs Steps 160-180.

In Step 130, the compilable instruction is added to a subset of instructions. The subset includes compilable instructions from the quantum program. The subset may include one or more compilable instructions that are selected for compilation into a quantum circuit. In some cases, the method may accumulate compilable instructions into the subset before the subset is compiled and executed.

In Step 140, where it moves to the next instruction in the sequence of the quantum program.

In Step 150, in response to a determination in Step 120 that the instruction is a non-compilable instruction, it is determined whether the non-compilable instruction requires condition evaluation. Non-compilable instructions may or may not require an evaluation of a condition. For example, the non-compilable instruction ASSERT requires an evaluation of a condition. As another example, conditional branching instructions, such as DO-WHILE statement, UNTIL statement, SWITCH statement, CONDITIONAL GOTO statement, IF statement, or the like, may require the evaluation of the condition to select the branch to which the control flow continues.

In Step 160, in response to a determination that condition evaluation is required, the current subset of compilable instructions is compiled into an executable quantum circuit. A compiler may be utilized to compile the subset. In some cases, a Directed Acyclic Graph (DAG) may be created based on the subset, compiled into functional-level circuit, which may be compiled into gate-level circuit. Additionally, or alternatively, an intermediate logical representation may be constructed, which may later be compiled or transpiled into physical representation. The compilation can utilize embodiments described in U.S. Pat. No. 11,281,988, entitled “Re-generation of a gate-level quantum circuit based on gate-level analysis”, dated Mar. 22, 2022, U.S Patent Application publication No. 2023/0,112,525, entitled “Provisioning functional-level information to be utilized in gate-level processing of quantum circuits”, dated Apr. 13, 2023, U.S. Pat. No. 11,416,762, entitled “Selecting physical qubits for quantum error correction schemes”, dated Aug. 16, 2022, U.S. Pat. No. 11,995,515, entitled “DAG-Based CSP quantum circuit modeling”, dated May 28, 2024, U.S. Patent Application Publication No. 2023/0, 111,236, entitled “Compiling quantum programs”, dated Apr. 13, 2023, U.S. Pat. No. 11,615,337, entitled “Determining quantum error correction schemes”, dated Mar. 28, 2023, all of which are hereby incorporated by reference in their entirety for all purposes without giving rise to disvowment.

The outcome of the compilation may be an executable quantum circuit that can be executed by a target quantum computer. The quantum circuit is then executed. The execution may be performed on a quantum execution platform, such as a quantum computer or a quantum simulator. The executable quantum circuit is configured to provide a state whose value is useful for evaluating the condition.

In Step 170, the outcome of the execution is determined. In some cases, there may be multiple executions in order to determine an outcome. For example, where quantum state tomography is performed, multiple executions may be required to reconstruct the quantum state and evaluate the condition. The number of executions may be determined. In some cases, the programmer may define the number of executions required. Additionally, or alternatively, the number of executions may be determined automatically, such as based on the error rate of the quantum circuit, the level of accuracy or precision required for the evaluation, or the like. In some cases, after several executions are performed, it may be determined that the outcome is not statistically significant above a desired threshold, and therefore additional executions may be performed. In some cases, the programmer may define a lower bound of minimal number of executions. Additionally, or alternatively, the programmer may define an upper bound of maximal number of executions. After determining the outcome, or if the non-compilable instruction does not require condition evaluation (no branch from Step 150), the method proceeds to Step 180.

In Step 180, the subset may be reset. The reset operation may be performed in response to a START non-compilable statement, which indicates that the program execution should begin from a new starting point.

Additionally, or alternatively, in Step 180 the next instruction for analysis may be determined. The next instruction for analysis is normally determined based on the next line in the sequence of instructions (e.g., as explained with respect to Step 140). However, if the current instruction is an unconditional GOTO non-compilable statement, then the next instruction is the instruction at the label specified by the GOTO statement. If the current instruction is a conditional branching instruction, such as an IF statement, CONDITIONAL GOTO statement or WHILE statement, the next instruction would be the instruction in the selected branch based on the evaluation of the condition. In other cases, such as when the current instruction is a START statement, the next instruction is the next line in the sequence of instructions, similar to Step 140.

After Step 180, the process returns to Step 120 to continue the analysis with the next instruction. This iterative process allows for the dynamic selection, compilation, and execution of subsets of compilable instructions based on the evaluation of non-compilable control flow instructions. This approach enables the integration of classical control flow structures into quantum programming, potentially making quantum programming more accessible and efficient.

Once the quantum program is fully analyzed and no additional instruction exists (e.g., either after Step 180 or Step 140), the current subset may be considered as final and may be compiled and executed, providing the output of the quantum program. It is noted that the final subset that is being compiled may include compilable instructions that were previously included in a subset that was compiled and executed (e.g., an early compilation step). In some cases, such as when the START statement is used, the subset may exclude at least one compilable instruction that was included in a previously executed subset. Additionally, or alternatively, the final subset may exclude one or more compilable instructions that are included in the quantum program, such as instructions in non-taken branches. In some cases, the final subset may include a plurality of copies of the same compilable instruction from the quantum program, such as in the case of a loop structure or backward GOTO statements.

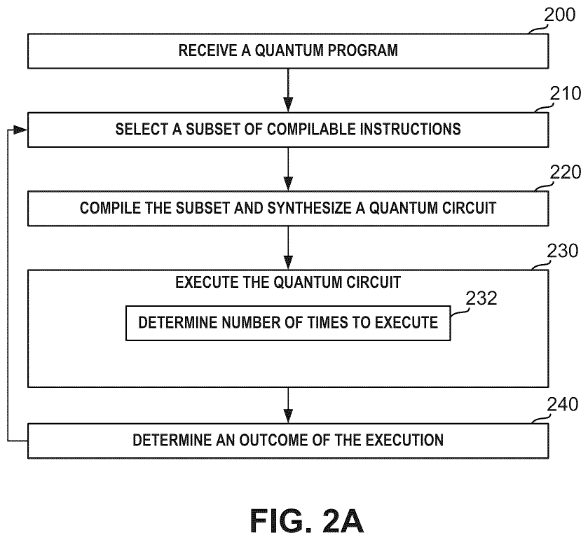

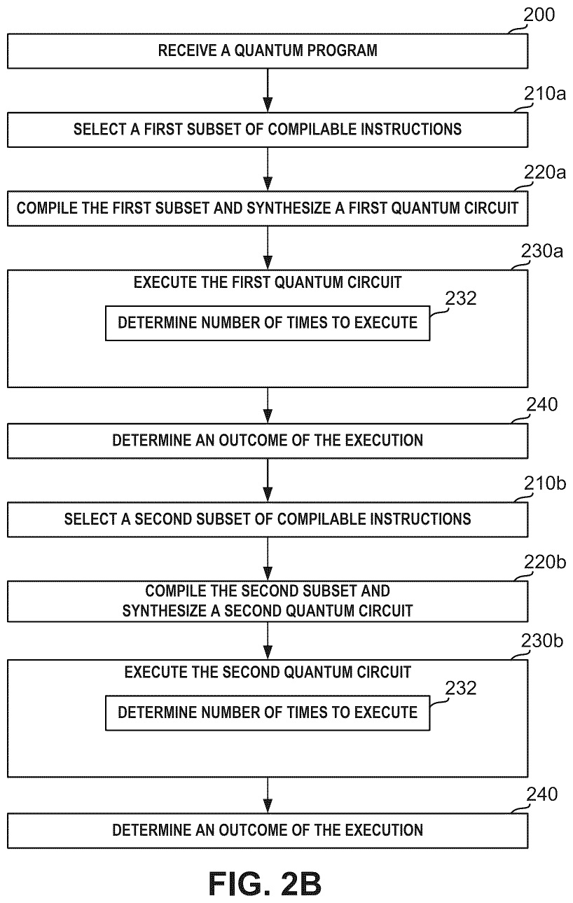

Referring to FIG. 2A, the figure illustrates a flowchart for a method of processing a quantum program, in accordance with some exemplary embodiments of the disclosed subject matter.

In Step 200, a quantum program is received. The quantum program includes a sequence of instructions. In some exemplary embodiments, the sequence of instructions includes both compilable instructions and non-compilable instructions. Compilable instructions may be instructions that can be directly translated into quantum gates or operations. Non-compilable instructions may be instructions that guide the compilation and execution process but do not directly correspond to quantum gates or operations. In some cases, some portions of gates or operations in the quantum circuit may correspond to a non-compilable instruction but such portions may not perform the functionality defined by the non-compilable instruction. Non-compilable instructions may include, for example, classical control flow instructions such as IF, WHILE, GOTO, or the like. Non-compliable instructions may include ASSERT in which a condition is evaluated and execution may proceed only if the condition is held. While the non-compilable instruction may cause some gates or operations to be included in the quantum circuit to assist in evaluating the condition, the decision made based on the value of the condition is not implemented within the quantum circuit. An additional non-compilable instruction may be a START statement. The sequence of instructions defines an order between the instructions.

In Step 210, a subset of the compilable instructions is selected from the quantum program. The selection is performed in view of one or more non-compilable instructions in the quantum program. The subset may include one or more compilable instructions that are selected for compilation into a quantum circuit. In some cases, the method may accumulate compilable instructions into the subset before the subset is compiled and executed. For example, the selection may be based on control flow determined based on a non-compilable instruction. Additionally, or alternatively, the selection may be based on instructions appearing before the non-compilable instruction. Additionally, or alternatively, the selection may be based on a START statement which excludes instructions that were previously encountered.

In Step 220, the selected subset of instructions is compiled and synthesized into a quantum circuit. A compiler may be utilized to compile the subset. In some cases, a Directed Acyclic Graph (DAG) may be created based on the subset, compiled into functional-level circuit, which may be compiled into gate-level circuit. Additionally, or alternatively, an intermediate logical representation may be constructed, which may later be compiled or transpiled into physical representation. The outcome of the compilation may be an executable quantum circuit that can be executed by a target quantum computer. The quantum circuit is then executed. The execution may be performed on a quantum execution platform, such as a quantum computer or a quantum simulator. The executable quantum circuit is configured to provide a state whose value is useful for evaluating the condition.

In Step 230, the quantum circuit is executed. Within this step, there is a sub-step 232 to determine the number of times to execute the quantum circuit. This indicates that the quantum circuit may be executed multiple times as part of the process. The number of times the quantum circuit is executed may be determined based on the non-compilable instruction. For example, if the non-compilable instruction is an ASSERT instruction, the quantum circuit may be executed multiple times to evaluate the condition specified by the ASSERT instruction. The number of times the quantum circuit is executed may be determined based on the error rate of the quantum circuit, the level of accuracy or precision required for the evaluation, or the like. In some cases, after several executions are performed, it may be determined that the outcome is not statistically significant above a desired threshold, and therefore additional executions may be performed. In some cases, the programmer may define a lower bound of minimal number of executions. Additionally, or alternatively, the programmer may define an upper bound of maximal number of executions. Additionally, or alternatively, the number of times to execute the quantum circuit may be determined based on the number of executions required to reconstruct a quantum state using quantum state tomography or using other techniques. Quantum state tomography involves performing a series of measurements on a quantum system to reconstruct the quantum state. This process may require multiple executions of the quantum circuit, with each execution providing a set of measurement results that contribute to the reconstruction of the quantum state. The reconstructed quantum state can then be used to evaluate the condition specified by the non-compilable instruction. This approach allows for more accurate and robust condition evaluation, potentially improving the reliability and performance of the quantum program.

Following the execution, the method proceeds to Step 240, where an outcome of the execution of the quantum circuit is determined. This step involves analyzing the results obtained from the quantum circuit execution. The outcome may be used to evaluate the condition specified by the non-compilable instruction. The outcome may be a Boolean value, a numerical value, a quantum state, or the like. The outcome may be used to determine the subsequent program flow, such as which branch to take in a conditional statement, how many times to repeat a loop, or whether to terminate the program. The outcome may also be used to adjust the parameters of the quantum program, such as the number of qubits, the gate sequence, the error correction scheme, or the like.

Referring to FIG. 2B, the figure illustrates a flowchart for a method of executing a quantum program, exemplifying two different subsets being compiled and executed, in accordance with some exemplary embodiments of the disclosed subject matter.

In Step 210a, a first subset of the compilable instructions is selected from the quantum program. The selection is performed in view of a non-compilable instruction in the quantum program. The subset may include one or more compilable instructions that are selected for compilation into a quantum circuit. In some cases, the method may accumulate compilable instructions into the subset before the subset is compiled and executed.

In Step 220a, the first subset of instructions is compiled and synthesized into a first quantum circuit.

In Step 230a, the first quantum circuit is executed. Within this step, there is a sub-step 232 to determine the number of times to execute the quantum circuit.

Following the outcome determination, Step 210b involves selecting a second subset of compilable instructions. The second subset may be different than the first subset. In some cases, the second subset may include the first subset and one or more additional compilable instructions. Additionally, or alternatively, the second subset may include some of the instructions in the first subset and exclude others. Additionally, or alternatively, the second subset may exclude all instructions in the first subset, such that there is no overlap therebetween.

In some embodiments, the first and second subsets are different. In some cases, there are instructions that are excluded from the first subset and included in the second subset. In some cases, the first subset is subsumed by the second subset. The second subset could exclude instructions associated with a branch not taken according to the outcome of the first quantum circuit. The second subset could include all compilable instructions in the quantum program. In some cases, the second subset may include all compilable instructions that the control flow directs to be executed.

This second subset is then compiled and synthesized into a second quantum circuit in Step 220b. The process continues with Step 230b, which executes the second quantum circuit. Similarly to the first execution, this step includes a sub-step 232 to determine the number of times to execute the circuit. However, the number of executions may differ in Step 230a from the number of executions in Step 230b. The total number of executions may include the number determined for step 230a added with the total number determined for step 230b.

The flowchart demonstrates an iterative approach to quantum program execution, where different subsets of instructions are compiled and executed in sequence. This method allows for dynamic adaptation of the quantum circuit based on intermediate results, potentially optimizing the overall quantum computation process.

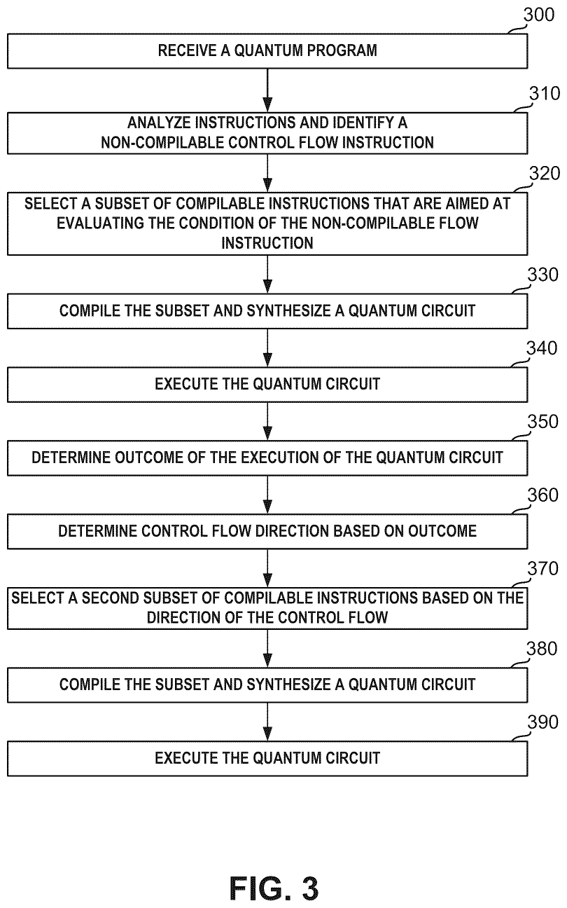

Referring to FIG. 3, the figure illustrates a flowchart for a method of processing a quantum program, in accordance with some exemplary embodiments of the disclosed subject matter.

In Step 300, a quantum program is received, similarly to Step 200 of FIG. 2A.

In Step 310, the method analyzes the instructions and identifies a non-compilable control flow instruction. The non-compilable control flow instruction may be associated with a condition that needs to be evaluated to determine the control flow of the quantum program. The non-compilable control flow instruction may be an IF statement, a WHILE statement, a CONDITIONAL GOTO statement, or the like.

In Step 320, a subset of the compilable instructions is selected. The subset includes compilable instructions from the quantum program. The subset may include one or more compilable instructions that are selected for compilation into a quantum circuit. In some cases, the method may accumulate compilable instructions into the subset before the subset is compiled and executed. The selection of the subset may be based on the non-compilable control flow instruction identified in Step 310. For example, the subset may include compilable instructions that appear before the non-compilable control flow instruction in the sequence of instructions. The subset may be aimed at evaluating the condition associated with the non-compilable control flow instruction. The subset may include instructions appearing in accordance with an execution path, before the condition is evaluated.

In Step 330, the selected subset is compiled and synthesized into a quantum circuit, similarly to Step 220 of FIG. 2A.

In Step 340, the quantum circuit is executed, similarly to Step 230 of FIG. 2A.

In Step 350, the outcome of the execution of the quantum circuit is determined, similarly to Step 240 of FIG. 2A.

In Step 360, based on the outcome of the execution, the control flow direction is determined. The control flow direction may be determined based on the evaluation of the condition associated with the non-compilable control flow instruction. For example, if the non-compilable control flow instruction is an IF statement, the control flow direction may be determined based on whether the condition is true or false. If the condition is true, the control flow may proceed along the true branch of the IF statement. If the condition is false, the control flow may proceed along the false branch of the IF statement. As another example, if the non-compilable control flow instruction is a CONDITIONAL GOTO statement, then if the condition is evaluated to be true, the next instruction for analysis is determined to be the labeled instruction to which the CONDITIONAL GOTO statement points. If the condition is evaluated to be false, the next instruction would be the next instruction according to the order of the sequence of instructions of the quantum program (e.g., the instruction in the next line).

In Step 370, a second subset of the compilable instructions is selected. The second subset may be different than the first subset. The selection of the second subset may be based on the control flow direction determined in Step 360. For example, if the control flow direction is along the true branch of an IF statement, the second subset may include compilable instructions that appear in the true branch of the IF statement. If the control flow direction is along the false branch of an IF statement, the second subset may include compilable instructions that appear in the false branch of the IF statement. The second subset may include all the instructions leading to the branch and instructions stemming from the branch itself. In some cases, non-compilable instructions appearing in the branch or afterwards may affect the subset and exclude instructions therefrom (e.g., START statement).

In Step 380, the second subset of instructions is compiled and synthesized into a second quantum circuit. The second quantum circuit may be different than the first quantum circuit. The second quantum circuit may include quantum gates or operations that correspond to the compilable instructions in the second subset. The second quantum circuit may be configured to provide a state whose value is useful for evaluating a condition specified by a non-compilable control flow instruction.

In Step 390, the second quantum circuit is executed, similarly to Step 340. In some cases, the second subset represents the execution of the quantum program itself, and not an early compilation step that is intended to determine control flow decision.

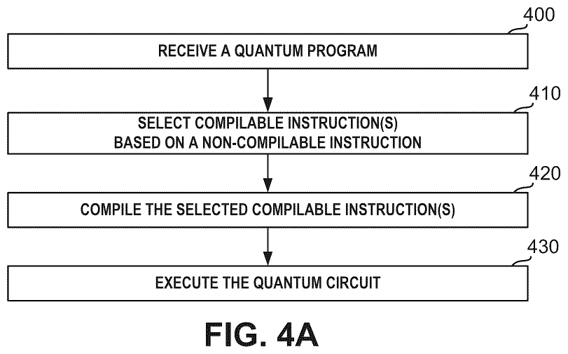

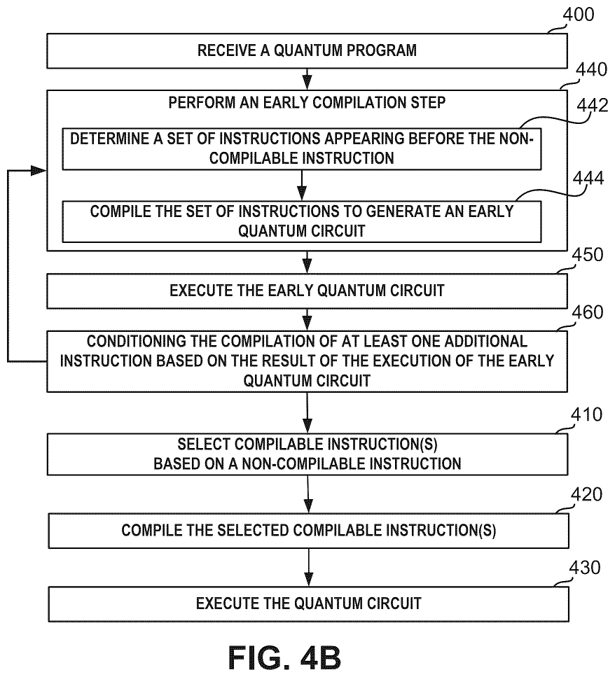

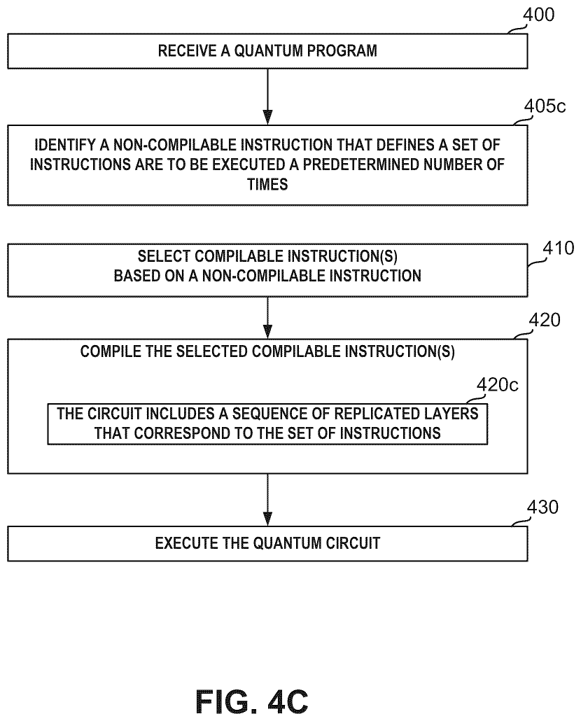

Referring to FIG. 4A, the figure illustrates a flowchart for a method of processing a quantum program, in accordance with some exemplary embodiments of the disclosed subject matter.

In Step 400, a quantum program is received, similarly to Step 200 of FIG. 2A. The quantum program includes a sequence of instructions. In some exemplary embodiments, the sequence of instructions includes both compilable instructions and non-compilable instructions.

In Step 410, at least one compilable instruction is selected from the sequence of instructions, The selected compilable instructions are selected for compiling to synthesize a quantum circuit that is configured to provide the defined outcome of the quantum program. The selection may be performed based on a type of a non-compilable instruction, based on a position of the non-compilable instruction in the sequence, a combination thereof, or the like. For example, if the non-compilable instruction is an IF statement, the selection may be based on the taken branch of the IF statement. As another example, if the non-compilable instruction is a WHILE statement, the selection may include a plurality of instances of the compilable instructions within the loop defined by the WHILE statement, and may be based on the number of times the loop is being executed. As another example, if the non-compilable instruction is a GOTO statement, the selection may be based on the label specified by the GOTO statement. As another example, if the non-compilable instruction is a START statement, the selection may be based on the position of the START statement in the sequence. The selection may omit compilable instructions, such as instructions appearing in non-taken branches, instructions jumped over by GOTO instructions, instructions omitted due to START statement, or the like.

In Step 420, the selected at least one compilable instruction is compiled. The compilation may be performed similarly to Step 220 of FIG. 2A. The compilation may be performed using a compiler. The outcome of the compilation may be a quantum circuit that can be executed by a quantum execution platform. The quantum circuit may include quantum gates or operations that correspond to the selected compilable instruction. The quantum circuit may be configured to provide the desired outcome of the quantum program.

In Step 430, the quantum circuit is executed. Execution may be performed similarly to Step 230 of FIG. 2A. The execution may be performed on a quantum execution platform, such as a quantum computer or a quantum simulator. The quantum circuit may be executed to provide a result of the quantum program. The result may be a Boolean value, a numerical value, a quantum state, or the like. For example, the result may be a solution to an optimization problem, such as finding the optimal route for a delivery truck; a prediction for a complex system, such as weather patterns or financial markets (e.g., the outcome could be a set of probabilities for different weather scenarios in a specific region over the next week); results related to molecular simulations for drug discovery (e.g., the outcome might be a list of potential drug candidates ranked by their likelihood of effectively binding to a target protein); a factorization of a large number, which could be used in breaking certain encryption schemes; an optimized set of parameters for a neural network; a simulation of the properties of new materials (e.g., conductivity, strength, or thermal properties); or the like.

Referring to FIG. 4B, the figure illustrates a flowchart for a method of processing a quantum program, in accordance with some exemplary embodiments of the disclosed subject matter.

In Step 440, an early compilation step is performed. The early compilation step may involve compiling and executing at least one instruction appearing in the sequence before the position of the non-compilable instruction. The early compilation step may be performed to evaluate a condition associated with a non-compilable instruction, such as an IF statement, a WHILE statement, a CONDITIONAL GOTO statement, ASSERT statement, or the like. The early compilation step may be performed to determine the control flow of the quantum program.

In Step 442, a set of instructions appearing before a non-compilable instruction is determined. The set of instructions may include one or more compilable instructions that are selected for compilation into a quantum circuit. The set of instructions may be determined based on the position of the non-compilable instruction in the sequence of instructions. For example, if the non-compilable instruction is an IF statement, the set of instructions may include all compilable instructions that appear before the IF statement in the sequence of instructions. The set of instructions may represent execution up until reaching the non-compilable instruction referred to in Step 410.

In Step 444, the set of instructions is compiled to generate an early quantum circuit. The early quantum circuit may include quantum gates or operations that correspond to the set of instructions. The early quantum circuit may be an executable quantum circuit that represents partial execution of the quantum program that is executed for the purposes of compilation, such as determining execution flow and selection of instructions based thereon. The early quantum circuit may be configured to provide a state whose value is useful for evaluating the condition associated with the non-compilable instruction.

In Step 450, the early quantum circuit is executed. The execution may be performed on a quantum execution platform, such as a quantum computer or a quantum simulator. The early quantum circuit may be executed to provide a result that is useful for evaluating the condition associated with the non-compilable instruction. In some embodiments, the early quantum circuit may be executed a plurality of times. The number of executions may be determined. The determination may be performed similarly to Step 232 of FIG. 2A. Additionally, or alternatively, the determination may be based on the evaluated condition, properties of the early quantum circuit, or the like.

In Step 460, the method conditions the compilation of at least one additional instruction based on the result of the execution of the early quantum circuit. The additional instruction may be a compilable instruction that is selected for compilation into a quantum circuit. The additional instruction may be selected based on the result of the execution of the early quantum circuit. For example, if the result of the execution of the early quantum circuit indicates that a condition associated with an IF statement is true, the additional instruction may be a compilable instruction that appears in the true branch of the IF statement. If the result of the execution of the early quantum circuit indicates that the condition is false, the additional instruction may be a compilable instruction that appears in the false branch of the IF statement.

In some embodiments, an early compilation process that is performed as part of the compilation of the quantum program. The early compilation process involves selectively compiling and executing subsets of quantum instructions based on the presence and evaluation of non-compilable instructions, which may affect control flow or otherwise affect which instructions are to be executed and in what order.

In some exemplary embodiments, the method may involve performing at least two early compilation steps, each includes an execution of a different early quantum circuit. The number of times each early quantum circuit is executed may differ. For example, the first early compilation step may involve compiling and executing a first set of instructions a first number of times, and the second early compilation step may involve compiling and executing a second set of instructions a second number of times. The first and second numbers of times may be different. The first and second sets of instructions may be different. In some cases, the first set of instructions may be a subset of the second set of instructions. In some cases, the first and second sets of instructions may be disjoint. The number of times each early compilation step is repeated may be determined based on the non-compilable instruction, the error rate of the quantum circuit, the level of accuracy or precision required for the evaluation, or the like.

Referring to FIG. 4C, the figure illustrates a flowchart for a method of processing a quantum program, in accordance with some exemplary embodiments of the disclosed subject matter. This method may handle non-compilable instructions that define repeated execution of a set of compilable instructions.

In Step 405c, the method identifies a non-compilable instruction that defines a set of instructions to be executed a predetermined number of times. This step may involve analyzing the quantum program to identify specific control flow structures, such as FOR loops, that have a known number of iterations determined at compile-time. For example, a FOR statement with a fixed number of iterations may be identified during this step. In some cases, other looping constructions may also have a predetermined number of iterations, such as WHILE statement that is configured to count iterations and continue looping until reaching a predetermined number of iterations. The identification may include performing static analysis of the program to determine if the number of times that the loop will be executed is pre-determined or not.

In Step 420c, the compilation process handles the repetition defined by the non-compilable instruction. The resulting circuit includes a sequence of replicated layers that correspond to a replications of the set of instructions defined by the non-compilable instruction. These replicated layers may be arranged sequentially in the quantum circuit, forming a sequence that represents the repeated execution of the instruction set.

In some cases, the layers may be set in a sequence immediately one after the other in the circuit. In another case, the layers may be included one after the other in a DAG for compilation. When the DAG is compiled, the layers may be placed in a different arrangement, as the compiler would allow. This approach enables efficient implementation of loop-like structures in quantum programs, where the number of iterations is known at compile-time, without requiring dynamic control flow during execution.

The quantum circuit with replicated layers is then executed in Step 430. This step represents the actual running of the compiled quantum program on a quantum execution platform, which may include multiple executions of the replicated layers corresponding to the repeated set of instructions.

This method demonstrates how the system can handle non-compilable instructions that define repeated execution, translating them into a quantum circuit structure that efficiently represents the repetition without the need for classical control flow during execution. This approach may allow for optimization of quantum resources and potentially improve the overall execution efficiency of quantum programs with predetermined repetitive structures.

It is noted that early compilation steps and replications may be utilized in combination, depending on the quantum program itself.

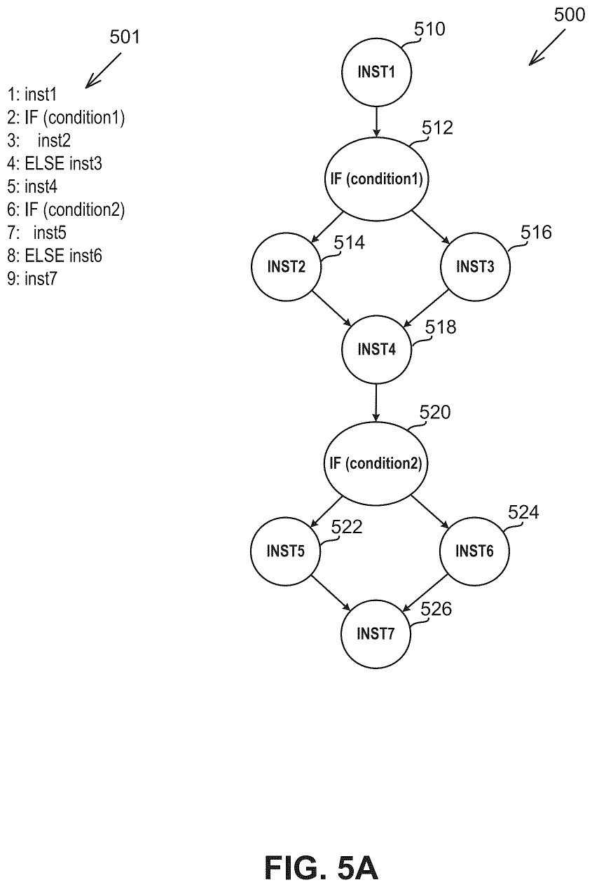

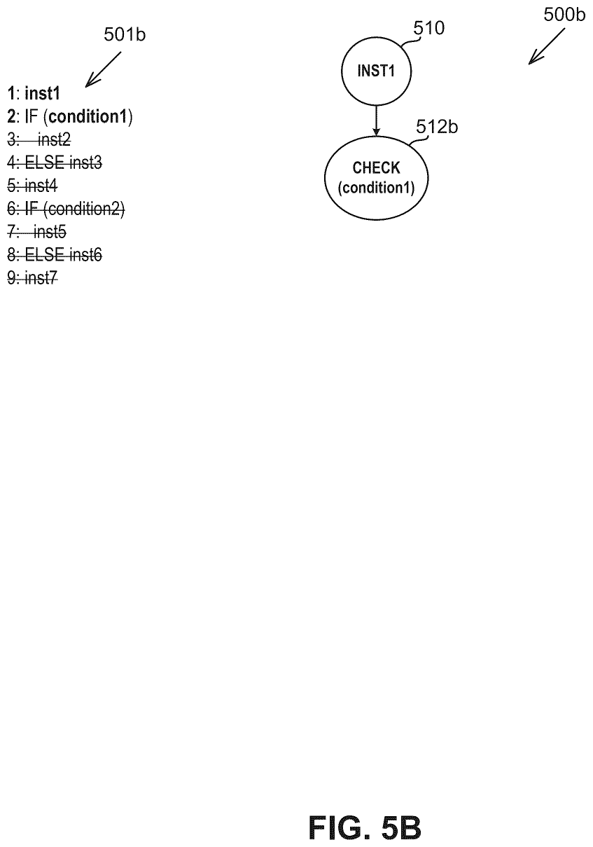

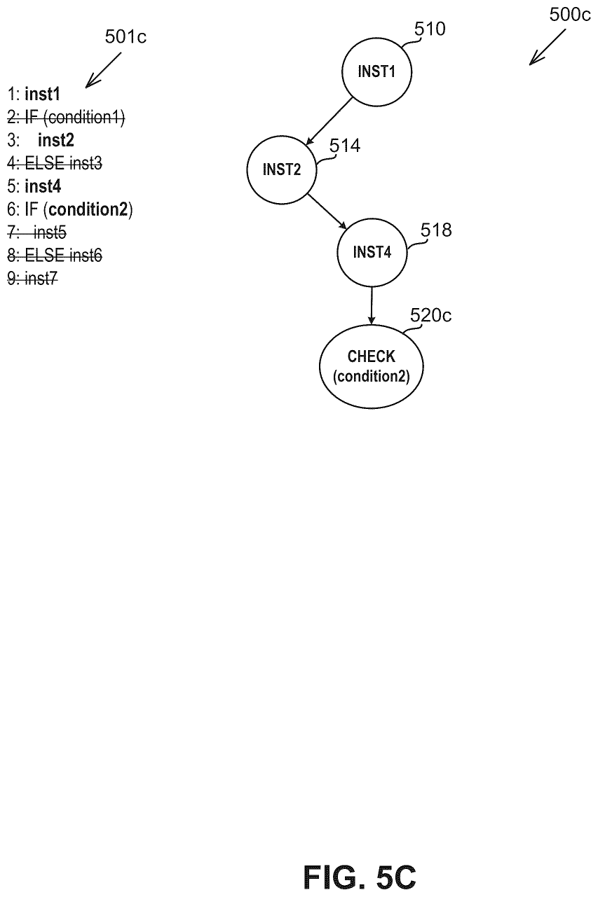

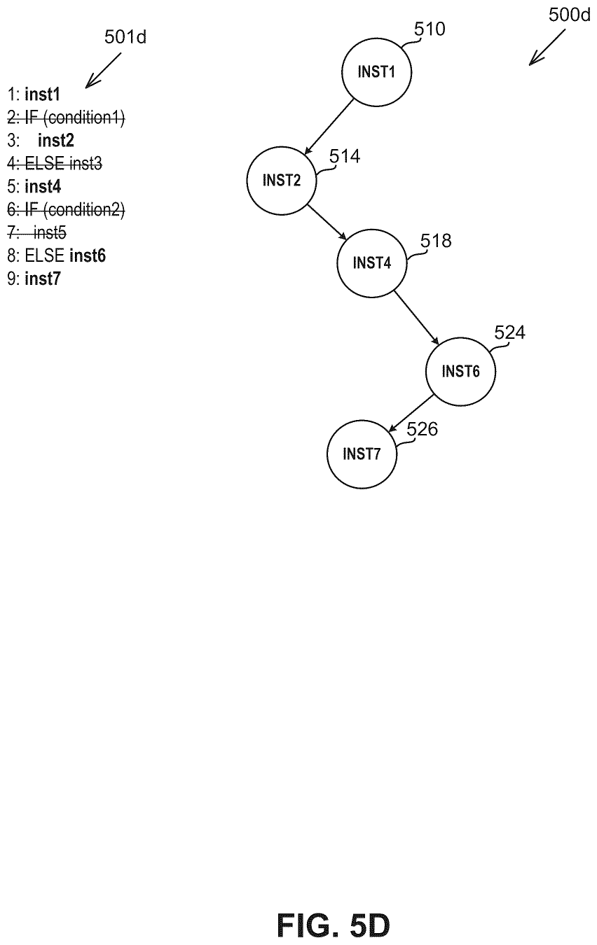

Referring to FIG. 5A, the figure illustrates a Control Flow Graph 500 representing a sequence of instructions 501 for a quantum program, in accordance with some exemplary embodiments of the disclosed subject matter.

The Control Flow Graph 500 visually represents the potential flow of execution through compilable and non-compilable instructions in a quantum program. The instruction sequence 501 is shown on the left side of the figure, containing a list of instructions numbered from 1 to 9, defining an order therebetween. These instructions correspond to the nodes in the Control Flow Graph 500.

The sequence begins with a compilable instruction 510, labeled as “INST1”, representing the instruction in line 1 of instruction sequence 501. This is followed by a non-compilable instruction 512, which represents an “IF (condition1)” statement (line 2). The graph then branches based on this condition. If the condition is true, the flow proceeds to compilable instruction 514 labeled “INST2” (line 3). If false, it goes to compilable instruction 516 labeled “INST3” (line 4). Both branches then converge at compilable instruction 518 labeled “INST4” (line 5). After instruction 518, there is another non-compilable instruction 520, representing an “IF (condition2)” statement (line 6). This creates another branch in the flow. If the second condition is true, the flow goes to compilable instruction 522 labeled “INST5” (line 7). If false, it proceeds to compilable instruction 524 labeled “INST6” (line 8). Both of these paths then merge at the final compilable instruction 526 labeled “INST7” (line 9).

The Control Flow Graph 500 demonstrates how the program execution can take different paths based on the evaluation of non-compilable conditional statements 512 and 520. The compilable instructions 510, 514, 516, 518, 522, 524, and 526 represent the quantum operations that can be directly translated into quantum circuits, while the non-compilable instructions 512 and 520 guide the overall program flow.

FIGS. 5B-5D show examples of execution paths of early quantum circuits and an execution path of the quantum circuit representing the quantum program. As is shown in these figures, some of the instructions in the instruction sequence 501 are excluded from the executed quantum circuit.

Referring to FIG. 5B, the figure illustrates an execution path of an early quantum circuit created in an early compilation step associated with instruction sequence 501 of FIG. 5A.

As opposed to Control Flow Graph 500 of FIG. 5A, which shows all potential execution paths, in FIG. 5B on a single execution path is shown: an execution path followed during the first early compilation step.

Instruction sequence 501b is shown on the left side of the figure, containing a list of instructions numbered from 1 to 9. Instruction sequence 501b shows the instructions that are being executed in execution path 500b. Non-executed instructions of instruction sequence 501 are shown with a strikethrough.

The execution path 500b shows the flow of execution for a portion of the instruction sequence. The subset of instructions that are selected, compiled and executed include only inst1 (510, labeled as “INST1”). The selection is based on encountering, at line 2, with a non-compilable instruction (IF statement). The execution path 500b ends with a condition check 512b, labeled as “CHECK (condition1)”. This check corresponds to the evaluation of the condition used in the IF statement in line 2 of the instruction sequence.

Based on the outcome of the execution, the condition can be evaluated and checked, and compilation of the instruction sequence 501 can continue.

This figure shows an early compilation step that is performed as part of the compilation of the quantum program that includes classical control flow instructions that are not compiled into specific gates in the quantum circuit. The early compilation step involves selectively compiling and executing subsets of quantum instructions based on the presence and evaluation of non-compilable control flow instructions.

In this early compilation step, when a non-compilable instruction is encountered, the system compiles and executes only the preceding compilable instructions. The result of this execution is then used to evaluate the condition associated with the control flow instruction. This allows the system to determine the subsequent program flow without compiling the entire quantum program at once. Based on the evaluation result, the system can then select and compile the next appropriate subset of instructions, effectively implementing conditional behavior in the quantum program.

Determining the outcome of the execution comprises evaluating the condition. The outcome of the execution may be used to evaluate the condition specified by the non-compilable instruction. The outcome may be a Boolean value, a numerical value, a quantum state, or the like. The outcome may be used to determine the subsequent program flow, such as which branch to take in a conditional statement, how many times to repeat a loop, or whether to terminate the program. The outcome may also be used to adjust the parameters of the quantum program, such as the number of qubits, the gate sequence, the error correction scheme, or the like.

In some cases, the early quantum circuit represented by execution path 500b may be executed a plurality of times, depending on the condition being checked in condition check 512b, depending on characteristics of the early quantum circuit, or the like.

Referring to FIG. 5C, the figure illustrates an execution path 500c of a second early compilation step, assuming the execution of the first early compilation step shown in FIG. 5B resulted in evaluation that the condition is held.

The instruction sequence 501c is shown on the left side of the figure, containing a list of instructions numbered from 1 to 9. Some instructions are crossed out, indicating they are not part of the current execution path.

The execution path 500c comprises four nodes arranged in a linear sequence. The first node represents a compilable instruction 510, labeled as “INST1”. This is followed by a second node representing another compilable instruction 514, labeled as “INST2”, which is within the taken branch of the IF statement (line 2). The third node represents a compilable instruction 518, labeled as “INST4” (line 5). The fourth and final node in the graph represents a non-compilable instruction 520c, labeled as “CHECK (condition2)”. This condition check corresponds to the “IF (condition2)” statement in line 6 of the instruction sequence 501c.

As can be appreciated, execution path 500c shares at least one compilable instruction with execution path 500b of FIG. 5B (e.g., INST1 510). Execution path 500c includes additional compilable instructions that are not included in execution path 500b (e.g., INST2 514, INST4 518). The selection of the compilable instructions included is based on the evaluation of the condition in the IF statement at line 2, which was evaluated during the first early compilation step, illustrated in FIG. 5B. Furthermore, the selection of the compilable instructions is also based on the second IF statement at line 6. Due to encountering such statement, a second early compilation step is performed with the instructions collected up until that point. Based on the outcome of the execution, the condition can be evaluated and checked, and compilation of the instruction sequence 501 can continue.

In some cases, the early quantum circuit represented by execution path 500c may be executed a plurality of times, depending on the condition being checked in condition check 520c, depending on characteristics of the early quantum circuit, or the like. It is noted, however, that the number of times that execution path 500c is executed and the number of times that execution path 500b is executed could be different and they may be determined independently of one another.

In some embodiment, the total number of executions required during the early compilation steps may be the summation of the number of executions of execution path 500b and the number of execution of execution path 500c. As this is the summation and not a multiplication, as each condition is evaluated independent, the disclosed subject matter is much more scalable than other methods that require analyzing all combinations.

Referring to FIG. 5D, the figure illustrates an execution path 500d of a quantum program. The execution graph 500d represents the flow of compilable instructions in the quantum program.

The instruction sequence 501d is shown on the left side of the figure, containing a list of instructions numbered from 1 to 9. Some instructions are crossed out, indicating they are not part of the execution path.

The execution path 500d begins with compilable instruction 510, labeled as “INST1”. This instruction is connected to compilable instruction 514, labeled “INST2”, followed by compilable instruction 518, labeled “INST4”. Up until compilable instruction 518, execution path 500d is identical to execution path 500c of FIG. 5C. As the last evaluation of condition2 (IF statement at line 6) is false, the control flows to the “else branch” and compilable instruction 524, labeled “INST6”, is executed. After the “else branch” is completed, compilable instruction 526, labeled “INST7” is executed.

The execution path 500d demonstrates that conditional statements and their associated branches have been resolved during the early compilation steps. Specifically, the IF statement at line 2 in the instruction sequence, along with its ELSE counterpart, has been evaluated and removed. Similarly, the IF Statement at line 6 in the instruction sequence, along with its TRUE counterpart, has been evaluated and removed. The resulting graph shows only the compilable instructions that will be executed in the final quantum circuit, creating a streamlined and optimized execution.

In some aspects, the second subset of compilable instructions that is compiled and executed in the final quantum circuit may include the first compilable instruction 510. This is evident in execution path 500d, where the first compilable instruction 510 appears as the first node in the graph. This demonstrates that the final quantum circuit may include compilable instructions that were part of the subsets compiled and executed in the early compilation steps. This allows for the preservation of necessary quantum operations from the early stages of the program execution, ensuring that the final quantum circuit accurately represents the intended quantum computation.

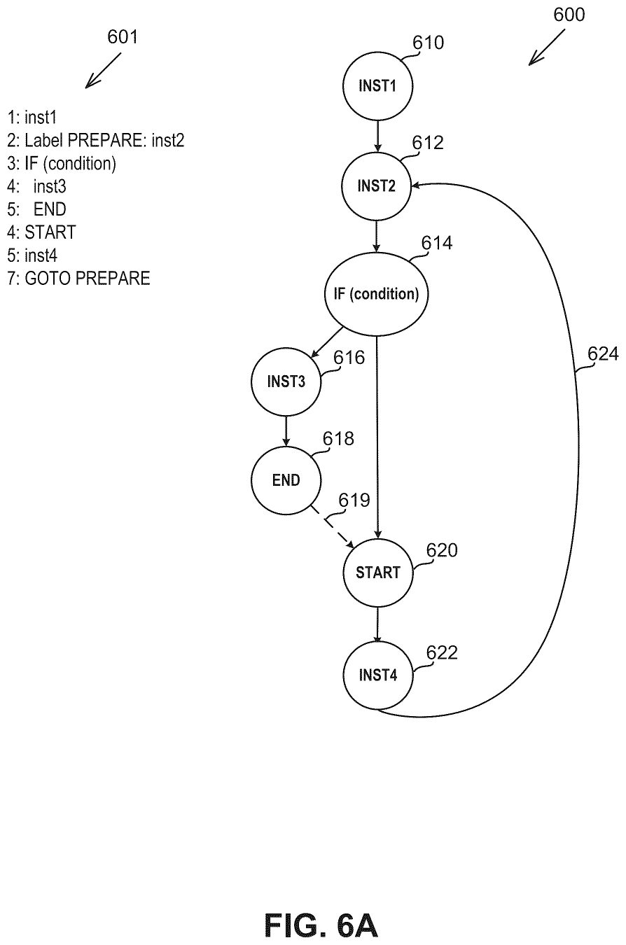

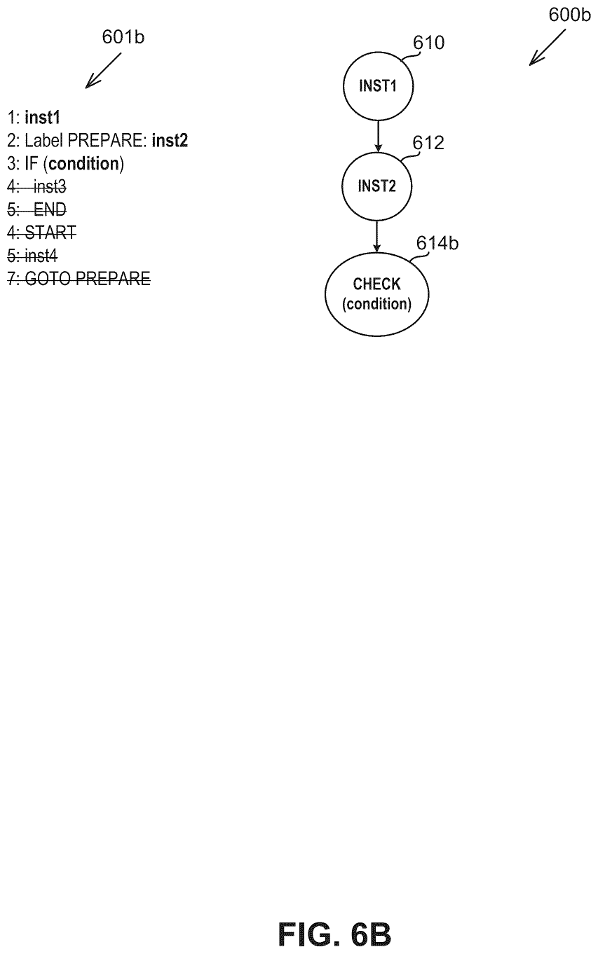

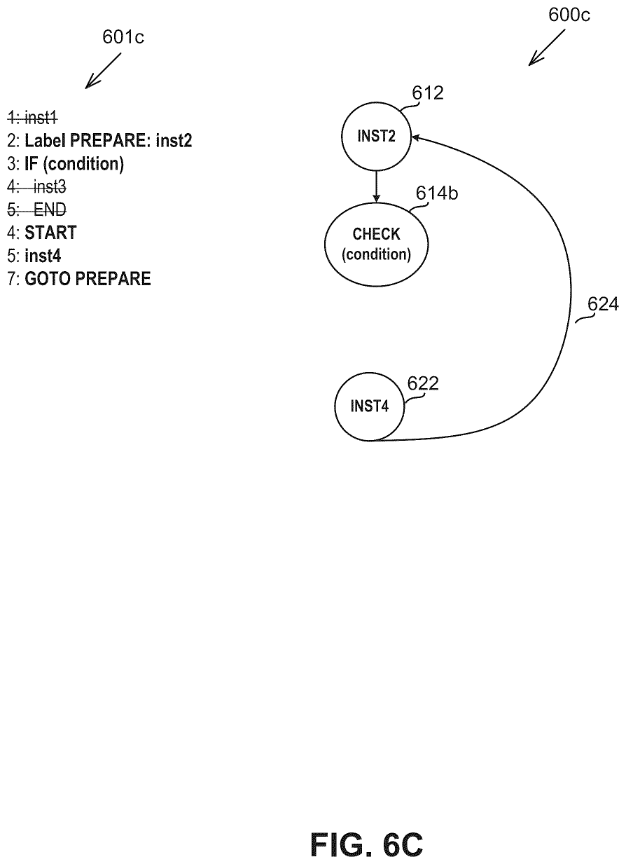

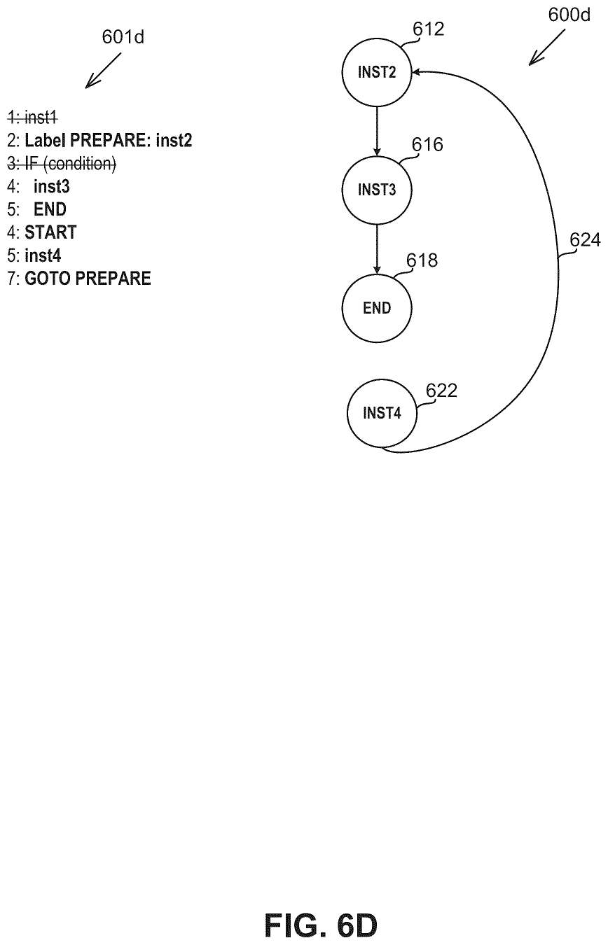

Referring to FIG. 6A, the figure illustrates a Control Flow Graph 600 representing a sequence of instructions 601 for a quantum program, in accordance with some exemplary embodiments of the disclosed subject matter.

The Control Flow Graph 600 visually represents the potential flow of execution through compilable and non-compilable instructions in a quantum program. The instruction sequence 601 is shown on the left side of the figure, containing a list of instructions numbered from 1 to 7, defining an order therebetween. These instructions correspond to the nodes in the Control Flow Graph 600.

The sequence begins with a compilable instruction 610, labeled as “INST1”, representing the instruction in line 1 of instruction sequence 601. This is followed by another compilable instruction 612, labeled as “INST2”, representing the instruction in line 2 of instruction sequence 601. These are connected sequentially, indicating they are executed in order.

A non-compilable instruction 614, labeled “IF (condition)”, follows instruction 612. This represents a conditional branch in the program flow. If the condition is true, the flow proceeds to compilable instruction 616, labeled “INST3”, followed by a non-compilable instruction 618, labeled “END”.

If it were not for the END instruction, control would continue in accordance with deleted Arrow 619. However, END indicates that the program end at that point and flow does not continue on.

If the condition in instruction 614 is false, the flow continues to non-compilable instruction 620, labeled “START”. This may indicate the beginning of a new section in the program.

Following the “START” instruction 620, there is a compilable instruction 622, labeled “INST4”.

A Goto Arrow 624 connects instruction 622 back to instruction 612, creating a loop structure in the program flow. This loop allows for repeated execution of a portion of the program. The GOTO Arrow 624 corresponds to the GOTO instruction at line 7 of the instruction sequence 601 which points to the instruction in line 2, using the defined label “PREPARE”.

In one embodiment, specific instructions could be utilized. As an example, inst1 (line 1) could be an initial state preparation step. Inst2 (line 2) could be a calculation that is performed based on the initial state. Condition of line 3 could be whether the outcome is “good enough”. If so, inst3 (line 4) may include post-processing and outputting the result. If not, inst4 (line 5) could be preparing a new initial state in view of the result of the condition of line 3.

The Control Flow Graph 600 demonstrates how the program execution can take different paths based on the evaluation of non-compilable conditional statements 614 and 620. The compilable instructions 610, 612, 616, 622 represent the quantum operations that can be directly translated into quantum circuits, while the non-compilable instructions 614, 618, 620 guide the overall program flow.

Referring to FIG. 6B, the figure illustrates an execution path 600b of a first early compilation step associated with the instruction sequence 601 of FIG. 6A. The instruction sequence 601b is shown on the left side of the figure, containing a list of instructions numbered from 1 to 7. Instruction sequence 601b shows the instructions that are being executed in execution path 600b. Non-executed instructions of instruction sequence 601 are shown with a strikethrough.

The execution path 600b shows the flow of execution for a portion of the instruction sequence. The subset of instructions that are selected, compiled and executed include compilable instructions 610, 612. The selection is based on encountering, at line 3, a non-compilable instruction (IF statement). The execution path 600b ends with a condition check 614, labeled as “CHECK (condition)”. This check corresponds to the evaluation of the condition used in the IF statement in line 3 of the instruction sequence 601b.

Based on the outcome of the execution, the condition can be evaluated and checked, and compilation of the instruction sequence 601 can continue. In this early compilation step, when a non-compilable instruction is encountered, the system compiles and executes only the preceding compilable instructions. The result of this execution is then used to evaluate the condition associated with the control flow instruction. This allows the system to determine the subsequent program flow without compiling the entire quantum program at once. Based on the evaluation result, the system can then select and compile the next appropriate subset of instructions, effectively implementing conditional behavior in the quantum program.

Determining the outcome of the execution comprises evaluating the condition. The outcome of the execution may be used to evaluate the condition specified by the non-compilable instruction. The outcome may be a Boolean value, a numerical value, a quantum state, or the like. The outcome may be used to determine the subsequent program flow, such as which branch to take in a conditional statement, how many times to repeat a loop, or whether to terminate the program. The outcome may also be used to adjust the parameters of the quantum program, such as the number of qubits, the gate sequence, the error correction scheme, or the like.

In some cases, the early quantum circuit represented by execution path 600b may be executed a plurality of times, depending on the condition being checked in condition check 614b, depending on characteristics of the early quantum circuit, or the like.

Referring to FIG. 6C, the figure illustrates an execution path 600c of a second early compilation step, assuming the execution of the first early compilation step shown in FIG. 6B resulted in evaluation that the condition is not held.

The instruction sequence 601c is shown on the left side of the figure, containing a list of instructions numbered from 1 to 7. Some instructions are crossed out, indicating they are not part of the current execution path.

After the condition of the IF statement at line 3 was determined to not be held, the next instruction that is encountered is a non-compilable instruction: START statement. Due to this non-compilable instruction, all previously encountered compilable instructions are removed from the subset. At that point in time, there are no compilable instructions included for compilation. Specifically, compilable instruction 610 and compilable instruction 612 appearing in execution path 600b were removed. The next instruction that is encountered according to the order of the instructions is inst4 at line 5, Accordingly, the first compilable instruction added to the subset is compilable instruction 622.

The next instruction is a non-compilable instruction: GOTO statement at line 7. This GOTO statement is unconditional and does not require condition evaluation. Accordingly, it points to a specific next instruction (at line 2), and compilable instruction 612 is added. The next instruction is a conditional non-compilable instruction (IF statement at line 2). Accordingly, the early quantum circuit is determined based on compilable instructions 622, 612, and a condition check 614 after their execution is performed, similarly to the check performed at FIG. 6B.

If the evaluation of the condition continues to be false, the same execution path (600c) will be executed again. When the condition is evaluated to true, execution path 600d will be executed, representing the quantum program itself.

Referring to FIG. 6D, the figure illustrates an execution path 600d of a quantum program. The execution path 600d represents the flow of compilable instructions in the instructions sequence 601d, representing the quantum program.

The instruction sequence 601d is shown on the left side of the figure, containing a list of instructions numbered from 1 to 7. Some instructions are crossed out, indicating they are not part of the execution path.

The execution path 600d begins similarly to execution path 600c, with compilable instruction 622, followed by compilable instruction 612 (due to Goto arrow 624). Due to the condition being evaluated as true, the control flow continues to line 4, and compilable instruction 616, labeled “INST3” is then executed. The execution continues to the END statement at line 5. This statement indicates that the execution should end at that point, without introducing additional quantum operations.

The execution path 600d demonstrates that conditional statements and their associated branches have been resolved during the early compilation steps. The resulting path shows only the compilable instructions that will be executed in the final quantum circuit, creating a streamlined and optimized execution.

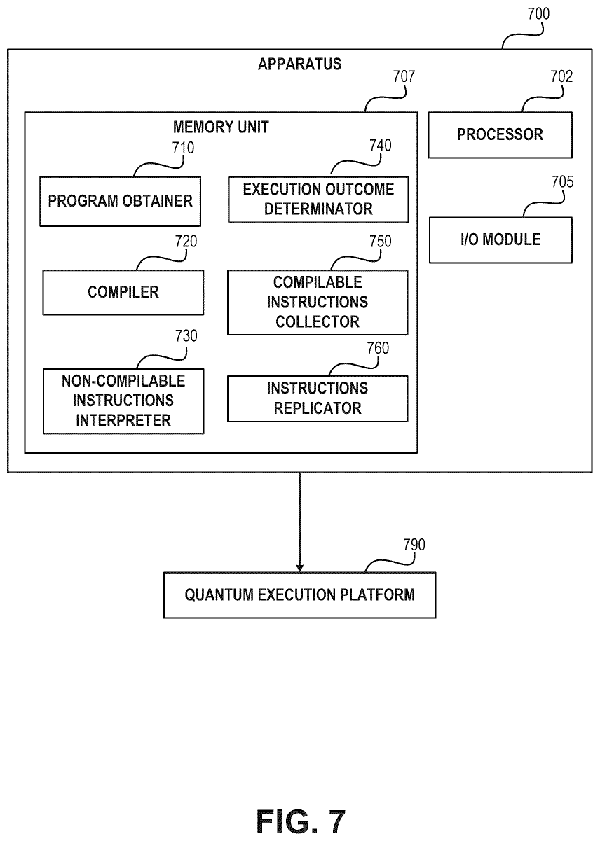

Referring to FIG. 7, the figure illustrates a block diagram of an apparatus 700 for processing quantum programs, in accordance with some exemplary embodiments of the disclosed subject matter. The apparatus 700 includes a Processor 702, an I/O Module 705, and a Memory Unit 707. Memory Unit 707 includes several components for handling quantum program execution.

Within Memory Unit 707, there is a Program Obtainer 710 for receiving quantum programs. Program Obtainer 710 may be configured to receive a quantum program comprising a sequence of instructions, including both compilable and non-compilable instructions. The quantum program may be received from an external source, such as a user input, a network connection, a storage device, or the like.

A Compiler 720 is included for compiling instructions and creating a quantum circuit that can be executed on Quantum Execution Platform 790. Compiler 720 may be configured to select subsets of compilable instructions based on non-compilable instructions, compile these subsets into quantum circuits, and manage the execution of these circuits on Quantum Execution Platform 790. Compiler 720 may also handle the replication of certain instructions as needed in case the non-compilable instruction calls for a pre-determined number of repetitions of a set of compilable instructions.

Memory Unit 707 includes a Non-Compilable Instructions Interpreter 730 for handling instructions that cannot be directly compiled, such as IF, WHILE, GOTO, END, START, ASSERT. The Non-Compilable Instructions Interpreter 730 may be configured to interpret non-compilable instructions within the quantum program, guide the selection of compilable instructions based on these non-compilable instructions, and manage the execution process accordingly.

Memory Unit 707 includes an Execution Outcome Determinator 740 for assessing the results of quantum circuit executions. Execution Outcome Determinator 740 may be configured to determine the outcome of each execution, evaluate conditions associated with non-compilable instructions, and guide the subsequent selection and compilation of compilable instructions based on these outcomes. In some cases, Execution Outcome Determinator 740 may be configured to determine a number of executions needs to evaluate a condition. The determination may be performed in advance before the execution. Additionally, or alternatively, a determination may be made after one or more executions were performed.

Memory Unit 707 includes a Compilable Instructions Collector 750 for gathering subsets of the instructions to be compiled, based on the non-compilable instructions, based on early compilation steps, based on previous executions and their outcomes, or the like. Compilable Instructions Collector 750 may be configured to select subsets of compilable instructions for compilation based on the evaluation of non-compilable instructions and the outcomes of previous executions. Compiler 720 may utilize Compilable Instructions Collector 750 to determine the subset of compilable instructions needed for compilation or for early compilation.

Memory Unit 707 includes an Instructions Replicator 760, which may be used for replicating certain instructions as needed in case the non-compilable instruction calls for a pre-determined number of repetitions of a set of compilable instructions. Instructions Replicator 760 may be configured to replicate certain compilable instructions in the quantum circuit based on non-compilable instructions that define repeated execution of a set of instructions.

Apparatus 700 is connected to Quantum Execution Platform 790, which is responsible for executing the compiled quantum circuits. Quantum Execution Platform 790 could be a quantum computer, a simulator of a quantum computer, or the like. Compiler 720 may be configured to synthesize a quantum circuit that is executable Quantum Execution Platform 790. In some cases, the compilation may depend on the specific type of hardware or implementation details within Quantum Execution Platform 790.

The components within the Memory Unit 707 work together to process quantum programs, compile executable instructions, interpret non-compilable instructions, and manage the execution of quantum circuits on Quantum Execution Platform 790.

Processor 702 coordinates the operations of the various components within the Apparatus 700, while the I/O Module 705 facilitates communication with external systems or users. Processor 702 may be a classic processor.

In some exemplary embodiments, the system may handle complex control structures in quantum programs, including nested classical control structures, and additional control flow structures like switch-case and try-catch blocks.

Nested classical control structures, such as an IF statement within a WHILE loop, can be processed based on the actual execution order. When the system encounters a non-compilable control flow instruction, it may compile and execute the preceding compilable instructions up to that point, evaluate the condition, and then select the next subset of instructions based on the evaluation result. This process is repeated for each nested control structure, allowing the system to dynamically adapt the quantum program execution based on multiple levels of conditional logic.

Additionally, or alternatively, the integration of classical control flow may also be applied on switch-case statements and try-catch blocks. A switch-case statement could be implemented as a series of IF statements with conditions based on the value of a variable, while a try-catch block could be implemented as an IF statement with a condition based on the occurrence of a specific error during quantum circuit execution.

In some aspects, the system may handle potential conflicts between multiple ASSERT statements within the same program execution. Each ASSERT is evaluated separately in a separate execution. This allows for independent evaluation of each condition, potentially improving the scalability and efficiency of quantum programs with complex control flow structures.

The ASSERT instruction in quantum programming may be a complex non-compilable instruction that can contain compilable instructions used in evaluating the assertion. The ASSERT may include a directive that specifies a condition to be checked. The ASSERT may involve multiple executions of a quantum circuit and additional quantum operations.

In some embodiments, an ASSERT instruction may include a set of compilable instructions to be executed before measurement. These instructions modify the quantum state to prepare it for the assertion check. Additionally, or alternatively, the ASSERT instruction may include a specification of the number of times to run the quantum circuit. Additionally, or alternatively, the ASSERT instruction may include a condition to be evaluated based on the measurement results of these multiple runs.

For example, an ASSERT instruction might be structured as follows:

```
ASSERT {
  H(qubit[1]); // Apply Hadamard gate to qubit 1
  MEASURE(qubit[1]); // Measure qubit 1
  RUN 70 TIMES; // Execute the circuit 70 times
  CHECK (RESULT == 1) > 20 TIMES; // Verify if at least 20
  executions resulted in 1
}
```

In this example, the ASSERT Applies a Hadamard gate to qubit 1 (a compilable instruction), measures qubit 1, specifies that the circuit should be run 70 times, and checks if the measurement result was 1 in more than 20 of these executions.

In some cases, the additional executions may not be performed if the condition is satisfied earlier. For example, if the check is determined to be held after fewer than the specified number of executions, the system may terminate the ASSERT evaluation early. Referring to the above example, if the check is determined to be held more 21 times after 40 executions, the system may terminate the ASSERT evaluation before completing the 70 executions, thus sparing 30 executions. This early termination may optimize resource usage and reduce overall execution time.

The ASSERT instruction may combine both compilable elements (quantum gates and measurements) with non-compilable elements (multiple executions and result checking). It allows for statistical verification of quantum states or operations, which may be useful in quantum computing due to its probabilistic nature.

When processing an ASSERT instruction, the system may compile the quantum operations specified within the ASSERT, execute the resulting circuit one or more times, collect and analyze the measurement results, evaluate the specified condition based on these results, determine whether to continue program execution or handle the case where the assertion fails, or the like.

In some cases, the system may manage quantum resources, such as qubit allocation, when dynamically compiling and executing different branches of classical control flow. Each execution is a different quantum circuit, and resource allocation is separate and independent of other executions. This approach can optimize the use of quantum resources, potentially reducing the overall number of qubits or qubit cycles required for a given computation.

A number of implementations have been described. Nevertheless, it will be understood that various modifications may be made without departing from the spirit and scope of the disclosure. Accordingly, other implementations are within the scope of the following claims.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
receiving a quantum program comprising a sequence of instructions, the sequence of instructions comprising compilable instructions and a non-compilable instruction;
selecting a first subset of the compilable instructions, wherein said selecting the first subset is performed based on the non-compilable instruction;
compiling the first subset of the compilable instructions, whereby obtaining a first quantum circuit;
executing the first quantum circuit using a quantum execution platform;
determining an outcome of the execution of the first quantum circuit;
selecting a second subset of the compilable instructions, wherein the first subset and the second subset are different; and
compiling the second subset of the compilable instructions, whereby obtaining a second quantum circuit that can be executed by the quantum execution platform.

2. The method of claim 1, wherein said selecting the first subset is performed based at least on a position of the non-compilable instruction in the sequence of instructions.

3. The method of claim 2, wherein the sequence of instructions comprises a first compilable instruction, the non-compilable instruction, and a second compilable instruction, arranged in that specific order within the sequence of instructions, wherein the first subset comprises the first compilable instruction and excludes the second compilable instruction, wherein the second subset comprises the second compilable instruction.

4. The method of claim 3, wherein the second subset comprises the first compilable instruction.

5. The method of claim 2, wherein the sequence of instructions comprises a first compilable instruction, the non-compilable instruction, a second non-compilable instruction, a second compilable instruction, arranged in that specific order within the sequence of instructions, wherein the first subset comprises the first compilable instruction and excludes the second compilable instruction, wherein the second subset comprises the second compilable instruction and excludes the first compilable instruction, wherein the second non-compilable instruction is an instruction that initiates a new phase of program execution or alters the control flow of the quantum program.

6. The method of claim 1 further comprises executing the second quantum circuit using the quantum execution platform.

7. The method of claim 1 further comprising repeatedly: selecting a subset of the compilable instructions, compiling the subset to obtain a quantum circuit, executing the quantum circuit, and determining control flow based on an outcome of the execution of the quantum circuit.

8. The method of claim 1, wherein said executing the first quantum circuit is performed a plurality of times, wherein a number of times the first quantum circuit is executed depends on the determination made for said determining the outcome of the execution of the first quantum circuit.

9. The method of claim 1, wherein said executing the first quantum circuit is performed a plurality of times, wherein the method further comprises performing quantum state tomography on results of the plurality of executions of the first quantum circuit to reconstruct a quantum state, wherein said determining the outcome is performed using the reconstructed quantum state.

10. The method of claim 1, wherein the non-compilable instruction is a control flow instruction that is based on an evaluation of a condition, wherein said determining the outcome of the execution of the first quantum circuit comprises evaluating the condition.

11. The method of claim 10, wherein the non-compilable instruction is selected from a group consisting of: IF statement, DO-WHILE statement, UNTIL statement, SWITCH statement, and CONDITIONAL GOTO statement.

12. A method comprising:
receiving a quantum program comprising a sequence of instructions, the sequence comprising a plurality of compilable instructions and at least one non-compilable instruction;
selecting at least one of the compilable instructions for compiling, wherein said selecting is performed based at least on a type of the non-compilable instruction and on a position of the non-compilable instruction in the sequence; and
compiling the selected at least one compilable instruction, whereby obtaining a quantum circuit that is executable by a quantum execution platform.

13. The method of claim 12, further comprising performing at least one early compilation step, wherein the early compilation step comprises:
compiling and executing at least one instruction appearing in the sequence before the position of the non-compilable instruction, and
conditioning compilation of at least one remaining instruction of the quantum program upon at least one result of said early compilation step.

14. The method of claim 13, wherein said early compilation step comprises repeatedly compiling and executing the at least one instruction appearing in the sequence before the position of the non-compilable instruction, for a predetermined number of times.

15. The method of claim 13, wherein said early compilation step comprises repeatedly compiling and executing the at least one instruction appearing in the sequence before the position of the non-compilable instruction until a predetermined condition is satisfied.

16. The method of claim 13, wherein the early compilation step comprises at least two early compilation steps, and each one of the early compilation steps is repeated for a different number of times.

17. The method of claim 13, wherein the at least one non-compilable instruction defines that a set of one or more compilable instructions is to be executed a predetermined number of times, wherein the predetermined number of times is ascertainable prior to execution of the quantum program, wherein the quantum circuit comprises a sequence of replicated layers, each of which corresponds to the set of one or more compilable instructions.

18. A system comprising:
a classical processor;
a quantum execution platform; and
wherein the system is configured to:
receive a quantum program comprising a sequence of instructions, the sequence of instructions comprising compilable instructions and a non-compilable instruction;
select a first subset of the compilable instructions, wherein the selection is performed based on the non-compilable instruction;
compile the first subset of the compilable instructions, whereby obtaining a first quantum circuit;
execute the first quantum circuit using the quantum execution platform;
after the execution of the first quantum circuit, select a second subset of the compilable instructions, wherein the first subset and the second subset are different; and
compile the second subset of the compilable instructions, whereby obtaining a second quantum circuit that can be executed by the quantum execution platform.

19. The system of claim 18, wherein the non-compilable instruction does not have a counterpart instruction in any of the first quantum circuit and the second quantum circuit.

20. The system of claim 18, wherein the non-compilable instruction is a control flow instruction that is based on an evaluation of a condition, wherein the evaluation of the condition is performed after the first quantum circuit is executed and based on an outcome thereof, wherein the second subset of the compilable instructions is determined based on the evaluation of the condition.
